(19) United States
(12) Patent Application Publication
(10) Pub. No.: US 2025/0342369 A1
(43) Pub. Date: Nov. 6, 2025

(54) COMPUTER-IMPLEMENTED METHOD, DATA STRUCTURE, DEVICE FOR PROVIDING AND/OR STORING A CHANGE HISTORY OF A KNOWLEDGE GRAPH

(71) Applicant: Robert Bosch GmbH, Stuttgart (DE)

(72) Inventor: Henrik Dibowski, Bad Liebenzell (DE)

(21) Appl. No.: 19/191,641

(22) Filed: Apr. 28, 2025

(30) Foreign Application Priority Data
May 3, 2024 (EP) 24 17 4053.9

(51) Int. Cl. G06N 5/022

(52) U.S. Cl. CPC G06N 5/022

(57) ABSTRACT

Computer-implemented method, data structure, device for providing and/or storing a change history of a first knowledge graph. The device includes at least one, in particular non-volatile, memory, wherein a second knowledge graph is stored on the at least one memory, wherein the second knowledge graph includes at least a part of the first knowledge graph, wherein the second knowledge graph includes the change history, wherein the change history includes at least one triple of the first knowledge graph as the subject, wherein the at least one triple comprises a predicate and an object, wherein the predicate and the object link triples of the first knowledge graph to a subgraph of the second knowledge graph, which subgraph includes information about the change made to the first knowledge graph.

### CROSS REFERENCE

The present application claims the benefit under 35 U.S.C. § 119 of European Patent Application No. EP 24 17 4053.9 filed on May 3, 2024, which is expressly incorporated herein by referenced in its entirety.

### FIELD

The present invention related to a computer-implemented method, a data structure, and a device for providing and/or storing a change history of a knowledge graph.

### BACKGROUND INFORMATION

Knowledge graphs are used in databases to store information about a subject area. A knowledge graph can provide, in response to a request, the information that the knowledge graph stores at the point in time of the request.

A change history that comprises a change or changes to the information stored in the knowledge graph can be stored, for example, in a resource description framework, RDF, database for the knowledge graph. An example of an RDF database is described in Ontotext GraphDB Documentation Release 10.6.2, 26 Mar. 2024, available at graphdb.ontotext.com/documentation/10.6/pdf/GraphDB.pdf.

### SUMMARY

Using certain features of the present invention, a history of changes can be tracked.

For example, change history comprises information that indicates how the information stored in a knowledge graph has modified over time.

For example, the change history comprises information that indicates who or what caused a change to the information stored in the knowledge graph, or when or how a change to the information stored in the knowledge graph was initiated.

Using the change history, an earlier version of the knowledge graph can be restored starting from a version of the knowledge graph that exists after a change to the information stored in the knowledge graph.

Using the change history, from the knowledge graph currently available at a point in time, information from a time prior to the point in time, i.e., a reply that comprises information from the past, can be provided.

According to an example embodiment of the present invention, from a knowledge graph that exists at a later point in time, any version of the knowledge graph can be restored to an earlier point in time. A change history of an older version of the knowledge graph can also be ascertained or used by including the point in time in the change history request, so that only the changes up to that point in time are considered and transmitted.

The change history can provide source information, i.e., information about who or what caused a change to the information stored in the knowledge graph, or when or how a change to the information stored in the knowledge graph was initiated.

Using the change history, a change to the information in the knowledge graph can be undone or repaired, or be merged with information already stored in the knowledge graph.

Using the change history, a database based on the knowledge graph can provide information from different points in time when determining a reply to a request.

According to an example embodiment of the present invention, the knowledge graph stores the information in triples. A triple comprises, e.g., two nodes and an edge of the knowledge graph, in particular in the form node—predicate—node, wherein the edge is the predicate. A triple comprises, e.g., a node, a predicate and a literal, in particular in the form node—predicate—literal, wherein the literal comprises, e.g., a truth value (i.e., true or false), a text or a data value. A node is, e.g., an instance, a class, or a property.

The change history makes possible the complete traceability of all changes made to the knowledge graph down to the smallest possible granularity, i.e., down to changes in individual triples.

According to an example embodiment of the present invention, a device for providing and/or storing a change history of a first knowledge graph provides that the device comprises at least one, in particular non-volatile, memory, wherein a second knowledge graph is stored on the at least one memory, wherein the second knowledge graph comprises at least a part of the first knowledge graph, wherein the second knowledge graph comprises the change history, wherein the change history comprises at least one triple that comprises a triple of the first knowledge graph as the subject, wherein the at least one triple comprises a predicate and an object, wherein the predicate and the object link the triple of the first knowledge graph to a subgraph of the second knowledge graph, in particular an RDF graph in the second knowledge graph, which subgraph comprises information about the change made to the first knowledge graph. The second knowledge graph stores at least a part of the first knowledge graph and the change history. This means that, unlike storing the change history in a file, repository, or database table, an evaluation of the change history is possible without formatting changes. The first and second knowledge graphs store the change history in triples, i.e., without compression. This means that the evaluation of the change history does not require decompression, as would be necessary with a database backup to a compressed file.

Preferably, according to an example embodiment of present invention, the information indicates how the information stored in the first knowledge graph has modified over time, or who or what caused the change to the information stored in the first knowledge graph, or when or how the change to the information stored in the first knowledge graph was initiated.

Preferably, according to an example embodiment of the present invention, the first knowledge graph comprises information from the domain of physics, chemistry, medicine, biology, in particular about a technical system, preferably a factory or a building or a vehicle or a sensor or a digital imaging system or a computer network or a heating and/or cooling system, in particular information about a digital twin of a factory or a building or a vehicle or a sensor or a digital imaging system or a computer network or a heating and/or cooling system.

For example, according to an example embodiment of the present invention, the device is designed to incorporate a plurality of triples modified by the change in the subject of each triple of the change history, wherein the respective triples of the change history comprise the same object and predicate.

For example, according to an example embodiment of the present invention, the device comprises a computing device, wherein the computing device is designed to receive the change and to store it in the second knowledge graph, and wherein the device is designed to receive the information or to determine it according to the received change or a type of change or a point in time of receipt of the change, and to store it as part of the change history in the second knowledge graph. The computing device intercepts the changes in the first knowledge graph, e.g. from a communication with the first knowledge graph. The computing device can be designed to also intercept the information about the change for the change history from the communication with the knowledge graph, or to add the information itself according to the change or the type of change or the point in time of receipt of the change.

According to an example embodiment of the present invention, it can be provided that the computing device is designed to receive a request, in particular a SPARQL star query, for a change, wherein the device is designed to determine a response to the request with the second knowledge graph according to the request, wherein the computing device is designed to send the response, wherein the response comprises information for the change or information for undoing the change, wherein the information for the change indicates how the information stored in the first knowledge graph has modified over time, or who or what caused the change to the information stored in the first knowledge graph, or when or how the change to the information stored in the first knowledge graph was initiated.

According to an example embodiment of the present invention, it can be provided that the device is designed to determine the at least one triple, in particular to determine a triple that comprises the information, or to determine a plurality of triples that comprise the information. The triple from the change history annotates the modified triple that represents the change. As a result, the information from the triple in the change history is available for all elements of the triple, i.e., with the smallest possible granularity. Every individual change in the first knowledge graph can be extracted from the second knowledge graph. A plurality of triples modified by the change form, e.g., the subject of triples that contain at least a part of the information as an object and that comprise the same predicate. The object is, e.g., a node of a subgraph. For example, the subgraph describes part of the information.

According to an example embodiment of the present invention, it can be provided that the change in the first knowledge graph comprises removing the triple from the first knowledge graph or adding the triple to the first knowledge graph, or that the change in the first knowledge graph comprises updating the triple in the first knowledge graph, in particular by replacing the triple with another triple.

According to an example embodiment of the present invention, a method for providing and/or storing a change history of a first knowledge graph provides that a second knowledge graph is provided, wherein the second knowledge graph comprises at least a part of the first knowledge graph, and wherein the second knowledge graph comprises the change history, wherein the change history comprises at least one triple that comprises a triple of the first knowledge graph as the subject, wherein the at least one triple comprises a predicate and an object, wherein the predicate and the object link the triple of the first knowledge graph to a subgraph of the second knowledge graph, in particular an RDF graph in the second knowledge graph that comprises information about the change made to the first knowledge graph.

According to an example embodiment of the present invention, it can be provided that the change history is provided, wherein the change history comprises information indicating how the information stored in the first knowledge graph has modified over time, or wherein the change history comprises information indicating who or what caused a change to the information stored in the first knowledge graph, or when or how a change to the information stored in the first knowledge graph was initiated.

According to an example embodiment of the present invention, it can be provided that the first knowledge graph comprises information from the domain of physics, chemistry, medicine, biology, in particular about a technical system, preferably a factory or a building or a vehicle or a sensor or a digital imaging system or a computer network or a heating and/or cooling system, in particular information about a digital twin of a factory or a building or a vehicle or a sensor or a digital imaging system or a computer network or a heating and/or cooling system.

According to an example embodiment of the present invention, it can be provided that a plurality of triples modified by the change are incorporated in the subject of each triple of the change history, wherein the respective triples of the change history comprise the same object and predicate.

According to an example embodiment of the present invention, it can be provided that the change is received in the first knowledge graph and stored in the second knowledge graph, and wherein the information about the change is received in the second knowledge graph or is determined according to the received change or a type of change or a point in time of receipt of the change and is stored as part of the change history in the second knowledge graph, and/or that a request for a change is received in the first knowledge graph, a response to the request is determined using the second knowledge graph according to the request, and the response is sent, wherein the response comprises information for the change or information for undoing the change, wherein the information for the change indicates how the information stored in the first knowledge graph has modified over time, or who or what caused the change to the information stored in the first knowledge graph, or when or how the change to the information stored in the first knowledge graph was initiated.

According to an example embodiment of the present invention, it can be provided that the at least one triple is determined, in particular a triple that comprises the information, or a plurality of triples that comprise the information are determined.

According to an example embodiment of the present invention, it can be provided that the change in the first knowledge graph comprises removing the triple from the first knowledge graph or adding the triple to the first knowledge graph, or that the change in the first knowledge graph comprises updating the triple in the first knowledge graph, in particular by replacing the triple in the first knowledge graph with another triple.

According to an example embodiment of a data structure, in particular a computer-implemented data structure, for providing and/or storing a change history of a first knowledge graph provides that the data structure comprises at least one data field for a second knowledge graph, in particular for triples of the second knowledge graph, wherein the second knowledge graph comprises at least a part of the first knowledge graph, wherein the second knowledge graph comprises at least one modified triple of the first knowledge graph, and wherein the change history comprises at least one triple that comprises a triple of the first knowledge graph as the subject, wherein the at least one triple comprises a predicate and an object, wherein the predicate and the object link the triple of the first knowledge graph to a subgraph of the second knowledge graph, in particular an RDF graph in the second knowledge graph, which subgraph comprises information about the change made to the first knowledge graph.

Further advantageous embodiments of the present invention can be found in the following description and the figures.

### BRIEF DESCRIPTION OF THE DRAWINGS

FIG. 1 is a schematic representation of a database structure, according to an example embodiment of the present invention.

FIG. 2 is a flowchart with steps of a method for providing and/or storing a change history of a knowledge graph, according to an example embodiment of the present invention.

FIG. 3 is a schematic representation of a database structure, according to an example embodiment of the present invention.

### DETAILED DESCRIPTION OF EXAMPLE EMBODIMENTS

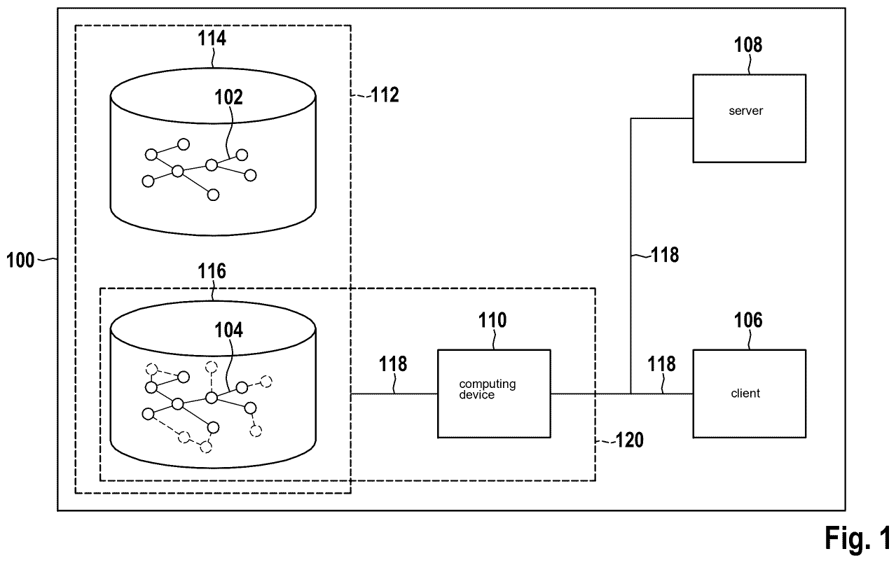

FIG. 1 schematically illustrates a schematic representation of a database structure 100.

The database structure 100 comprises a first knowledge graph 102 and a second knowledge graph 104. In the example, the database structure 100 can be used via an application that can run, e.g., on a client 106 or on a server 108.

The first knowledge graph 102 can comprise information about a factory or a building or a vehicle or a sensor or a digital imaging system or a computer network or a heating and/or cooling system.

For example, the first knowledge graph 102 represents information about a digital twin of a factory or a building or a vehicle or a sensor or a digital imaging system or a computer network or a heating and/or cooling system.

The database structure 100 in the example comprises a computing device 110.

In the example, the first knowledge graph 102 and the second knowledge graph 104 are stored on at least one memory 112. The first knowledge graph 102 and the second knowledge graph 104 may be stored on different memories.

In the example, the first knowledge graph 102 is stored in a first data set 114. In the example, the second knowledge graph 104 is stored in a second data set 116. In an initialization of the database structure 100, it can be provided that an initial first knowledge graph 102 and an initial second knowledge graph 104 are provided, wherein the second knowledge graph 104 comprises the first knowledge graph 102. In the example, the initial second knowledge graph 104 completely comprises the first initial knowledge graph 102.

The second knowledge graph 104 also comprises a change history.

The computing device 110 is designed to determine the change history.

The computing device 110 comprises, e.g., a software architecture and modules designed to determine the second knowledge graph 104 and the change history.

In the example, the computing device 110 is designed for communicating via a respective communication connection 118 with at least one memory 112, the client 106 and/or the server 108.

In the example, the computing device 110 is designed to receive requests to the first knowledge graph 102 for information and to determine and send responses to the requests to the first knowledge graph 102. In the example, the computing device 110 is designed to determine the responses to the requests to the first knowledge graph 102 according to information stored in the first knowledge graph 102. The information is stored in the first knowledge graph 102 in the form of triples. In the example, the response to a request comprises a plurality of triples, i.e. facts. In the example, the request defines the subject, the object, or the predicate of at least one triple that is sought as a response.

The computing device 110 is designed to receive a change request of the first knowledge graph 102 and to change information stored in the first knowledge graph 102 according to the change request. In the example, the change request defines the subject, the object, or the predicate of at least one triple to be modified. The change request defines, for example, how the subject, the object, or the predicate of the at least one triple to be modified is to be modified.

For example, the computing device 110 is designed to receive an add, remove, or change request, i.e., to remove and add information. For example, the computing device 110 is designed to add information according to the add request. For example, the computing device 110 is designed to remove information according to the remove request. For example, the computing device 110 is designed to remove information and add other information according to the change request. In the example, the add or remove request defines the subject, the object, or the predicate of at least one triple to be added or removed. The add request defines, for example, the subject, the object, or the predicate of the at least one triple to be added.

A device 120 for providing and/or storing a change history of the first knowledge graph 102 is designed to receive requests to the second knowledge graph 104 for information and to determine and send responses to the requests to the second knowledge graph 104. The device 120 is designed to determine the replies according to information stored in the second knowledge graph 104. The device 120 is designed to receive the requests from the client 106 or the server 108 and to send the response to the client 106 and/or the server 108.

The device 120 is designed to receive the change request of the first knowledge graph 102 and to change information stored in the second knowledge graph 104 according to the change request.

The device 120 is designed to receive the change requests from the client 106 or the server 108.

For example, the device 120 is designed to receive the add, remove, or change request, i.e. to remove and add information.

For example, the device 120 is designed to add information according to the add request. For example, the device 120 is designed to remove information according to the remove request.

For example, the device 120 is designed to remove information and add other information according to the change request.

The information is stored in the second knowledge graph 104 in the form of triples.

The device 120 is designed, e.g., to process the requests to the second knowledge graph 104 and the responses of the second knowledge graph 104 and the requests to the first knowledge graph 102 and the responses of the first knowledge graph 102 as described for the computing device 110.

In the example, the device 120 is designed to change the second knowledge graph 104 such that the second knowledge graph 104 comprises the first knowledge graph 102 modified by the change request. In the example, the first knowledge graph 102 is a subset of the second knowledge graph 104. In the example, each triple in the second knowledge graph 104 is additionally provided with meta information. Moreover, in the second knowledge graph 104, in the example, all triples that have ever existed in the first knowledge graph 102 up to this point in time also occur.

The first knowledge graph 102 contained in the second knowledge graph 104 or the part of the first knowledge graph 102 contained in the second knowledge graph is a subset of the first knowledge graph 102. After a change to the first knowledge graph 102, the second knowledge graph 104 comprises at least a part of the first knowledge graph 102 prior to the change. In the example, after the change, the modified first knowledge graph 102 is completely contained in the second knowledge graph 104.

The second knowledge graph 104 also comprises the change history. In the example, the change history comprises the triples of the initial first knowledge graph 102 that were removed from the first knowledge graph 102 by a change to the first knowledge graph 102. The change history also comprises, for the triples removed from the first knowledge graph 102 and for triples that were added to the first knowledge graph 102 in a change, or for triples of the first knowledge graph 102 that were modified in a change, one triple each that comprises information about the change or a plurality of triples in each case that comprise information about the change.

The information indicates, for example, how the information stored in the first knowledge graph 102 has modified over time.

The information indicates, for example, who or what caused the change to the information stored in the first knowledge graph 102.

The information indicates, for example, when or how a change to the information stored in the first knowledge graph 102 was initiated.

The device 120 is designed to receive or determine information for the change request of the first knowledge graph 102. The device 120 is designed to store the information for the change request in a change history in the second knowledge graph 104.

The information for the change request indicates, for example, who or what caused a change to the information stored in the first knowledge graph 102, or when or how a change to the information stored in the first knowledge graph 102 was initiated. The device 120 is designed to receive the information for the change request from the client 106 or the server 108.

In the example, the device 120 comprises the computing device 110 and the second knowledge graph 104. It can be provided that the device 120 comprises the first knowledge graph 102. It can be provided that the device 120 comprises the at least one memory 112.

It can be provided that the device 120 comprises the client 106 and/or the server 108.

In the example, the computing device 110 is designed to receive the change request and the information for the change request and to change the second knowledge graph 104 according to the request and the information for the request.

In the example, the computing device 110 is designed to receive the request to the second knowledge graph 104 and to determine and send the response to the request to the second knowledge graph 104.

In the example, the computing device 110 is designed to determine the reply according to information stored in the second knowledge graph 104. The request to the second knowledge graph 104 can relate to information from the first knowledge graph 102 or from the change history.

Here, it is possible to search for information that is no longer currently contained in the first knowledge graph 102, but was previously contained therein, since it is stored as history in the second knowledge graph 104. The search can relate to not only the origin, but also all other data, i.e. triples.

In an example for an implementation, the information stored in the second knowledge graph 104 is implemented as a set of RDF triples and RDF-star triples. For example, the respective request or response is implemented according to the SPARQL-star request language.

A request to the second knowledge graph 104 is, e.g., a SPARQL query or SPARQL-star query, in particular a SPARQL-star/Update query, a SPARQL-star/SELECT, a SPARQL/SELECT or a SPARQ-star/CONSTRUCT query.

In the example, SPARQL queries are used for both knowledge graphs. However, for the first knowledge graph 102 includes exclusively SPARQL queries, for the second knowledge graph 104 predominantly SPARQL-star queries, and in some cases SPARQL queries.

Specific examples for the request to the first knowledge graph 102:
SPARQL/Update DELETE/INSERT WHERE, SPARQL/Update DELETE DATA, SPARQL/Update INSERT DATA for the change
SPARQL/CONSTRUCT queries for calculating the delta of the change

Specific examples for the request to the second knowledge graph 104:
SPARQL-star/Update INSERT DATA for the change
SPARQL-star/SELECT or SPARQL/SELECT for the change history request
SPARQL-star/CONSTRUCT or SPARQL-star/Update DELETE/INSERT WHERE for restoring older versions

In the example, the first knowledge graph 102 comprises triples that represent the information stored in the first knowledge graph 102. The second knowledge graph 104 comprises triples that represent the triples from the first knowledge graph 102 and additional RDF triples and RDF-star triples that represent the change history.

The change history comprises, e.g., information that indicates how the information stored in the first knowledge graph 102 has modified over time.

The change history comprises, e.g., information indicating who or what caused a change to the information stored in the first knowledge graph 102.

The change history comprises, e.g., information that indicates when or how a change to the information stored in the first knowledge graph 102 was initiated.

In one example, the device 120, in particular the computing device 110, is designed to receive the SPARQL query and to process it with an ontology.

It can be provided that the device 120, in particular the computing device 110, if the query is a SPARQL/Update DELETE DATA and/or INSERT DATA query, is designed to receive a SPARQL query for performing a change to the first knowledge graph 102 and to forward it unmodified to the first knowledge graph 102 for performing the change to the first knowledge graph 102.

The device 120, in particular the computing device 110, is designed, e.g., to determine RDF-star triples and/or RDF triples from the second knowledge graph 104 according to the ontology and the SPARQL query.

The device 120, in particular the computing device 110, is designed, e.g., to execute a request on the second knowledge graph 104 according to the ontology and the SPARQL query, which request provides one or more triples from the second knowledge graph 104 as a response to the SPARQL query.

The ontology is an extension of PROV-O: The PROV Ontology described by Belhajjame, K.; Cheney, J.; Corsar, D.; Garijo, D.; Soiland-Reyes, S.; Zednik, S.; Zhao, J. W3C recommendation (2013), w3.org/TR/prov-o/.

The ontology comprises the main classes “prov:Entity”, “prov:Activity”, and “prov:Agent” defined by PROV-O. The ontology comprises the object properties “prov:wasGeneratedBy”, “prov:wasInvalidatedBy” and “prov:wasAssociatedWith” defined by PROV-O. The ontology comprises the data type properties “prov:generatedAtTime” and “prov:invalidatedAtTime” defined by PROV-O.

The extension refines the class “prov:Entity” with three new classes compared to PROV-O:
“provs:TripleChangeSet”:

The class “provs:TripleChangeSet” is a direct subclass of the class “prov:Entity”.

The class “provs:TripleChangeSet” is a class for a set of triples from the first knowledge graph 102 that have been modified by a change.
“provs:TripleGenerationSet”:

The class “provs:TripleGenerationSet” is a subclass of the class “provs:TripleChangeSet”. The class “provs:TripleGenerationSet” is a class for a set of triples that were inserted into the first knowledge graph 102 by a change.
“provs:TripleInvalidationSet”,

The class “provs:TripleInvalidationSet” is a subclass of the class “provs:TripleChangeSet”. The class “provs:TripleInvalidationSet” is a class for a set of triples that were removed from the first knowledge graph 102 by a change.

The extension comprises a new object property “provs:belongsTo” compared to PROV-O.

The object property “provs:belongsTo” is supported by RDF-star, i.e., the object property “provs:belongsTo” can be used to annotate a modified triple with an instance of the class “provs:TripleGenerationSet” or an instance of the class “provs:TripleInvalidationSet” in the second knowledge graph 104 with information for the change. In the example, TripleGenerationSet or TripleInvalidationSet is the object, and the modified triple is the subject.

Optionally, the extension comprises a class “provs:Query” with which a SPARQL/Update query that caused the change can be stored as information for the change in the second knowledge graph 104. An instance of the class “provs:Query” comprises, e.g. the SPARQL/Update query as text.

The information for the change is contained in the example in RDF triples and RDF-star triples. An RDF-star triple comprises a subject, a predicate and an object. An RDF-star triple has the special feature that the subject or object itself can be a triple. Here, triples are used in the subject of RDF-star triples. The ontology provides a vocabulary that is suitable for describing the change in an RDF triple or RDF-star triple or in a plurality of RDF triples or RDF-star triples.

An exemplary SPARQL/Update query comprises, e.g., a SPARQL/Update DELETE DATA query and a SPARQL/Update INSERT DATA query as subqueries:

DELETE DATA {
d:ACU-0b9aff9c o:isReleased false.
};
INSERT DATA {
d:ACU_0b9aff9c o:isReleased true.
d:ACU_0b9aff9c o:releaseDATE “2023-11-12”\hat{ }\hat{ }xsd:date.
};

where “o:isReleased” represents a data type property “isReleased” and “d:ACU_0b9aff9c” represents an instance “ACU_0b9aff9c”. This SPARQL/Update query changes the state “isReleased” of an instance from “false” to “true” and adds the date “releaseDATE”.

The subquery “DELETE DATA” removes a triple from the first knowledge graph 102, namely the triple that assigns the value “false” of the data type property “isReleased” to the instance “ACU_0b9aff9c”.

The subquery “INSERT DATA” adds a triple to the first knowledge graph 102, namely the triple that assigns the value “true” of the data type property “isReleased” to the instance “ACU_0b9aff9c”.

The subquery “INSERT DATA” adds a second triple to the first knowledge graph 102, namely the triple that assigns the value “2023-11-12”\hat{ }\hat{ }xsd:date of the data type property “releaseDate” to the instance “ACU_0b9aff9c”.

It can be provided that the device 120, in particular the computing device 110, is designed to receive a SPARQL query and to transform it into a SPARQL star query using a transformation. It can be provided that the device 120, in particular the computing device 110, is designed to apply the SPARQL star query to the second knowledge graph 104.

Due to the RDF star triples and the specific chosen ontology representation, less storage space is required compared to RDF reification, with which meta information for a triple must be represented as follows, because no meta information for triples can be represented with RDF:
tripleA hasSubject subjectInstance.
tripleA hasPredicate propertyIRI.
tripleA hasObject objectInstanceORLiteral.
tripleA hasMetaInfo “meta info . . . ”

Thus, at least 4 triples are needed instead of one.

In one example, when storing the changes or the change history, only data is written to the second knowledge graph 104 without first reading data from the second knowledge graph 104 or finding data in the second knowledge graph 104 and without adapting existing data of the second knowledge graph. The high efficiency of storing changes and change history in the second knowledge graph 104 lies in the fact that only data needs to be written there, without reading/finding data beforehand and without adapting existing data. The generated SPARQL-star/INSERT DATA queries contain virtually all RDF and RDF-star triples explicitly and only need to be added to the second knowledge graph 104, without any read operation and without changing existing triples.

When reading the change history, the chosen data structure is easier and faster to read than with RDF reification and the use of SPARQL.

Compared to RDF reification and SPARQL, this also offers the possibility of determining an older version of the first knowledge graph 102 more quickly with fewer computing resources.

The transformation itself is subsequently described using the example of the transformation of the SPARQL/Update query into the SPARQL-star/Update query.

As a result of the SPARQL star/update query, the second knowledge graph 104 comprises the removed triple embedded in a first RDF star triple, i.e., as the subject of the first RDF star triple. The first RDF star triple comprises a predicate with the object property “provs:belongsTo” and as an object an instance of the class “provs:TripleInvalidationSet”. This means that the first RDF star triple associates the remote triple with an instance of the class “provs:TripleInvalidationSet” via the object property “provs:belongsTo”.

In each case, a change can remove and/or add a plurality of triples. In the example, the change comprises one deleted and two added triples. The first RDF star triple is the deleted one, the second RDF star triple and the third RDF star triple are the added triples. As a result of the SPARQL star/update query, the second knowledge graph 104 comprises the two added triples embedded in a second or third RDF star triple, i.e. as the subject of the second or third RDF star triple. The second or third RDF star triple comprises a predicate with the object property “provs:belongsTo” and as an object an instance of the class “provs:TripleGenerationSet”. This means that the second or third RDF star triple associates the two added triples with the same instance of the class “provs:TripleGenerationSet” via the object property “provs:belongsTo”.

The second knowledge graph 104 can comprise further triples that describe the change. In the following example, the first three triples are RDF-star, and all others are normal RDF triples.

```
<< d:ACU_0b9aff9c o:isReleased false >>
  provs:belongsTo s:TripleInvalidationSet_2834417e.
<< d:ACU_0b9aff9c o:isReleased true >>
  provs:belongsTo s:TripleGenerationSet_2834417e.
<< d:ACU_0b9aff9c o:releaseDate “2023-11-12”\hat{ }\hat{ }xsd:date >>
  provs:belongsTo s:TripleGenerationSet_2834417e.
s:TripleInvalidationSet_2834417e rdf:type
provs:TripleInvalidationSet;
  prov:invalidatedAtTime “2023-11-
13T12:36:18.444Z”\hat{ }\hat{ }xsd:dateTime;
  prov:wasInvalidatedBy s:Activity_2834417e;
.
s:TripleGenerationSet_2834417e
  rdf:type provs:TripleGenerationSet;
  prov:generatedAtTime “2023-11-13T12:36:18.444Z”\hat{ }\hat{ }xsd:dateTime;
  prov:wasGeneratedBy s:Activity_2834417e;
.
s:Activity_2834417e
  rdf:type prov:Activity;
  rdfs:label “released ACU_and added a release date”;
prov:wasAssociatedWith s:Agent_“Agent Name”;
.
s:Agent_ “Agent Name”
  rdf:type prov:Agent;
  rdfs:label “ “Agent Name” ”;
```

In the example, instances of the PROV-O class “prov:Agent” represent an originator of the change and instances of the PROV-O class “prov:Activity” represent an activity that caused the change. In the example, a PROV-O data type property “prov:invalidatedAtTime” represents a point in time of removal, “prov:wasInvalidatedBy” the activity that triggered the removal, “prov:generatedAtTime” a point in time of creation, “prov:wasGeneratedBy” the activity that triggered the creation and “prov:wasAssociatedWith” the originator of the activity. “Agent Name” can identify a person or an application.

In the example, the change history comprises RDF triples and RDF-star triples, which contain information about respective incremental changes made to the first knowledge graph 102.

In the example, the second knowledge graph 104 comprises at least one RDF-star triple for each triple from the first knowledge graph 102, which links the information about the change.

It can be provided that a plurality of RDF star triples with the same object and predicate exist in the second knowledge graph 104. They annotate the simultaneously modified triples with the same change. For example, an RDF star triple in the object is an instance for which the origin of the triples is defined via further RDF triples.

A result of transforming the exemplary SPARQL/Update query into an exemplary SPARQL-star/Update query is:

```
INSERT DATA {
<< d:ACU_0b9aff9c o:isReleased false >>
  provs:belongsTo s:TripleInvalidationSet_2834417e.
<< d:ACU_0b9aff9c o:isReleased true >>
  provs:belongsTo s:TripleGenerationSet_2834417e.
<< d:ACU_0b9aff9c o:releaseDate “2023-11-12”\hat{ }\hat{ }xsd:date >>
  provs:belongsTo s:TripleGenerationSet_2834417e.
s:TripleInvalidationSet_2834417e rdf:type
provs:TripleInvalidationSet.
s:TripleInvalidationSet_2834417e prov:invalidatedAtTime
  “2023-11-13T12:36:18.444Z”\hat{ }\hat{ }xsd:dateTime.
s:TripleInvalidationSet_2834417e prov:wasInvalidatedBy
s:Activity_2834417e.
s:TripleGenerationSet_2834417e rdf:type
provs:TripleGenerationSet.
s:TripleGenerationSet_2834417e prov:generatedAtTime
“2023-11-13T12:36:18.444Z”\hat{ }\hat{ }xsd:dateTime.
s:TripleGenerationSet_2834417e prov:wasGeneratedBy
s:Activity_283447e.
s:Activity_2834417e rdf:type prov:Activity.
  s:Activity_2834417e rdfs:label “released ACU and added a
release date”. S:Activity_2834417e prov:wasAssociatedWith
s:Agent_ “Agent Name”.
  s:Agent_ “Agent Name” rdf:type prov:Agent.
  s:Agent_“Agent Name” rdfs:label ““Agent Name””.
}
```

In the example, 2834417e designates a unique identifier that is added to each new instance as a postfix, in order to ensure that there is no other instance in the second knowledge graph 104 with which the instance collides.

For example, the identifier of an instance is s:TripleInvalidationSet_2834417e in prefix notation. The prefix “s” is a placeholder for a URL, e.g. www.bosch.com/semantics#, as a result of which the identifier of the instance is actually the URL www.bosch.com/semantics#TripleInvalidationSet_2834417e.

In the example, the transformation uses a predefined SPARQL star template that defines the structure and possible content of the SPARQL star/update query.

Both subqueries (DELETE DATA, INSERT DATA) result in only one INSERT DATA SPARQL star query, which was described above.

Optionally, a transformation of a SPARQL DELETE INSERT WHERE query can be provided, which has a WHERE clause with which triples are determined from the first knowledge graph 102. A DELETE or INSERT clause of the query can delete or insert the triples specified in the WHERE clause. For example, the transformation provides a first additional SPARQL CONSTRUCT query with which the triples to be removed are determined. For example, it is provided to remove the triples ascertained with the first additional SPARQL CONSTRUCT query. For example, the transformation provides a second additional SPARQL star CONSTRUCT query with which the triples to be added are determined. For example, it is provided to add the triples ascertained with the second additional SPARQL star CONSTRUCT query.

The device 120, in particular the computing device 110, can be designed to evaluate the change history. For example, the device 120, in particular the computing device 110, is designed to apply a change history request to the second knowledge graph 104. Since the modified triples from the first knowledge graph 102 are stored as the subject of the RDF-star triples in the second knowledge graph 104, one can search directly for the subject, the object, and/or the predicate of the modified triples. For example, the request comprises a subject and a predicate and an object of the searched triple.

For example, the request comprises a subject and a predicate of the searched triple and a placeholder for the object of the searched triple(s). For example, the request comprises a subject of the searched triple and a placeholder for the predicate and object of the searched triple(s). For example, the request comprises an object and a predicate of the searched triple and a placeholder for the subject of the searched triple(s). For example, the request comprises an object of the searched triple and a placeholder for the predicate and subject of the searched triple(s). For example, the request comprises a subject and an object of the searched triple and a placeholder for the predicate of the searched triple (s). For example, the request comprises a predicate of the searched triple and a placeholder for the subject and object of the searched triple(s).

An exemplary SPARQL star/SELECT query comprises the following assignment of placeholders to a search pattern

```
SELECT ?time ?action ?subject ?pred ?object ?agentLabel
?activityLabel
WHERE {
{
  ?tripleChangeSet rdf:type provs:TripleGenerationSet.
  ?tripleChangeSet prov:wasGeneratedBy ?activity.
  ?tripleChangeSet prov:generatedAtTime ?time.
  FILTER (?time > “2023-11-13T12:00:00.000Z”\hat{ }\hat{ }xsd:dateTime)
  BIND (“CREATED” AS ?action).
} UNION {
  ?tripleChangeSet rdf:type provs:TripleInvalidationSet.
  ?tripleChangeSet prov:wasInvalidatedBy ?activity.
  ?tripleChangeSet prov:invalidatedAtTime ?time.
  FILTER (?time > “2023-11-13T12:00:00.000Z”\hat{ }\hat{ }xsd:dateTime)
  BIND (“DELETED” AS ?action).
}
  ?activity rdfs:label ?activityLabel.
  ?activity prov:wasAssociatedWith ?agent.
  ?agent rdfs:label ?agentLabel.
  <<?subject ?pred ?object>> provs:belongsTo ?tripleChangeSet.
}
```

The query defines a search for provs:TripleGenerationSet instances (?tripleChangeSet rdf:type provs:TripleGenerationSet.), provs:TripleInvalidationSet instances (?tripleChangeSet rdf:type provs:TripleInvalidationSet.) combined with further conditions.

The query thus searches for changes, since the changes are anchored in the second knowledge graph 104 via these two types of instances. The query searches for changes with further restrictions, e.g. that a certain lower or upper time limit is given.

In the search pattern, FILTER defines a condition and BIND assigns a string value, e.g. “CREATED” or “DELETED”, to the variable ?action in the search pattern. That is, in the query response, the fact that it is an added triple is evident due to the string value “CREATED” for the respective triple. The deleted triples receive the value “DELETED” for the variable ?action.

In the search pattern, ?time represents a placeholder for the point in time of the change, ?subject represents a placeholder for the subject of the searched triple, ?pred represents a placeholder for the predicate of the searched triple, ?object represents a placeholder for the object of the searched triple, ?agentLabel represents a placeholder for the cause, and ?activityLabel represents a placeholder for the activity that caused the change.

An exemplary sorting query according to the point in time of the change of a triple from the first knowledge graph 102 in descending order is, e.g.,
ORDER BY DESC(?time).

A SPARQL star CONSTRUCT query can be used to restore the first knowledge graph 102 at a specifiable point in time. An example for a query comprises:

```
CONSTRUCT { ?subject ?pred ?object }
WHERE {
  BIND(“2023-08-30T10:30:54.761Z”\hat{ }\hat{ }xsd:dateTime AS ?pastDateTime)
  ?tripleGenerationSet a provs:TripleGenerationSet.
  ?tripleGenerationSet prov:generatedAtTime ?timeOfGeneration.
  FILTER (?timeOfGeneration <= ?pastDateTime).
  <<?subject ?pred ?object>> provs:belongsTo
?tripleGenerationSet.
  FILTER NOT EXISTS {
    <<?subject ?pred ?object>> provs:belongsTo
    ?tripleInvalidationSet.
    ?tripleInvalidationSet prov:invalidatedAtTime
    ?timeOfInvalidation.
    FILTER (?timeOfInvalidation > ?timeOfGeneration &&
      ?timeOfInvalidation <= ?pastDateTime)
  }
}
```

In the query, ?pastDateTime represents a placeholder for the specifiable point in time.

The filter “FILTER (?timeOfGeneration<=?pastDateTime)” causes only generated triples (provs:TripleGenerationSet) that were generated prior to the given point in time to be searched.

The FILTER NOT EXISTS block ensures that triples that were created prior to the given point in time but were deleted afterwards and prior to the given point in time are excluded.

This is because these triples actually no longer exist at the given point in time.

The general logic of this query is:

Search for all triples generated prior to the given point in time. Sort out those that were deleted later, prior to the given point in time.

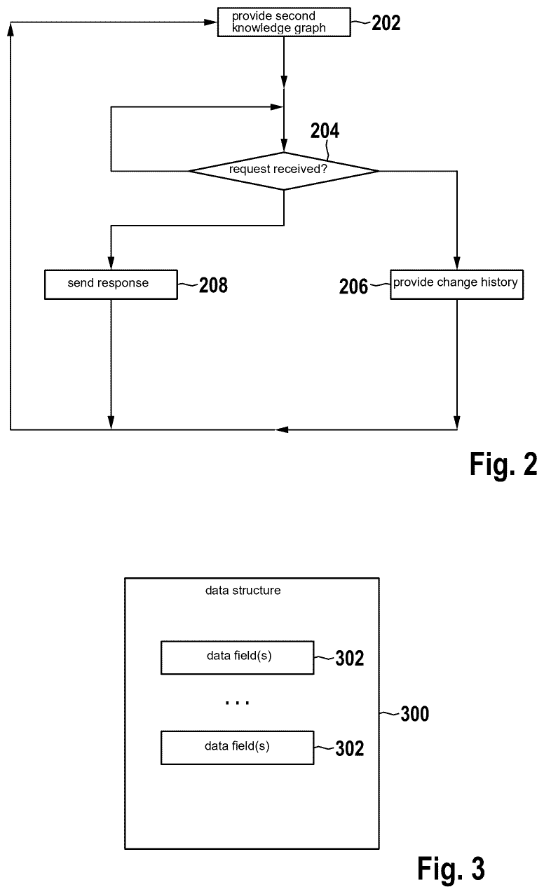

FIG. 2 shows a flowchart with steps of a method for providing and/or storing a change history of the first knowledge graph 102.

The method comprises a step 202.

In step 202, the second knowledge graph 104 is provided.

It can be provided that the first knowledge graph 102 and the second knowledge graph 104 are provided together in a first execution of the step 202 after the start of the method, or in an initialization. The second knowledge graph 104 comprises at least a part of the first knowledge graph 102.

The second knowledge graph 104 comprises the change history.

The first knowledge graph 102 comprises, e.g., triples that represent the information stored in the first knowledge graph 102. The second knowledge graph 104 is provided, e.g., with RDF triples and RDF-star triples, which represent the change history.

It can be provided that a SPARQL star/update query is executed on the second knowledge graph 104, which annotates the triples from the first knowledge graph 102 once with the same information, e.g. with a timestamp, i.e. information about a point in time of the copy, i.e. about when the change in the first knowledge graph 102 took place,
a cause, i.e. information about who caused the change to the information stored in the first knowledge graph 102,
a reason for the change, i.e. information about why the change of the information stored in the first knowledge graph (102) was initiated.

The cause is, e.g., a person or an application. The information about the cause is, e.g., a name of the person or the application. The reason is, e.g., an event, such as an initial setup. The information about the reason is, e.g., a name of the event.

The change history can be empty when the step 202 is executed for the first time, or during initialization.

A step 204 is subsequently executed.

In step 204 it is checked whether or not a request has been received.

If no request was received, step 204 is executed.

If a request has been received, it is checked whether the request relates to information for a change in the first knowledge graph 102 or a change that is to be made to the first knowledge graph 102.

If the request relates to a change to be made to the first knowledge graph 102, a step 206 is executed.

If the request relates to information for a change in the first knowledge graph 102, a step 208 is executed.

In step 206, the change and the change history are generated in the second knowledge graph 104. The change is made according to the request to change the first knowledge graph 102. This means that a copy of the changes to the first knowledge graph 102 is incrementally provided in the second knowledge graph 104.

In step 206, the change history is provided.

In step 206, for example, information about the change that is to be made or has been made in the first knowledge graph 102 according to the request to change the first knowledge graph 102 is stored as part of the change history in the second knowledge graph 104.

For example, for a modified triple that represents the change in the first knowledge graph 102, at least one RDF star triple is determined that represents the information about the change.

An RDF-star triple is created that contains the modified triple in the subject. The RDF star triple links the modified triple with an instance (object of the triple, instance of the class provs:TripleGenerationSet or provs:TripleInvalidationSet) that defines the changes via further triples.

The RDF-star triple contains the modified triple.

For example, RDF triples and RDF-star triples are determined, which comprise information about the change made to the first knowledge graph 102.

For example, an RDF star triple is determined that links the modified triple to an instance in the object (instance of the class provs:TripleGenerationSet or provs:TripleInvalidationSet), for which the change history is defined via further RDF triples.

For example, for a plurality of modified triples, RDF triples and RDF-star triples are determined that contain the information about the change.

It can be provided that the information about the change is received together with the request in step 204. For example, the request to change the first knowledge graph 102 comprises information for the change that indicates how to change the information stored in the first knowledge graph 102, or who or what caused the change to the information stored in the first knowledge graph 102, or when or how to cause the change to the information stored in the first knowledge graph 102.

It can be provided that the information about the change is determined according to the change received with the request in step 204.

For example, upon receiving a change that comprises removing a triple from the first knowledge graph 102, information about the change is determined that represents the removal of the triple from the first knowledge graph 102.

For example, upon receiving a change that comprises adding a triple to the first knowledge graph 102, information about the change is determined that represents the addition of the triple to the first knowledge graph 102.

The change in the first knowledge graph 102 can comprise updating a triple, in particular by replacing one triple with another triple.

For example, upon receiving a change that comprises replacing one triple from the first knowledge graph 102 with another triple, information about the change is determined that represents the replacement, i.e., the removal of one triple from the first knowledge graph 102 and the addition of the other triple to the first knowledge graph 102.

It can be provided, e.g., that the information about the change is determined as a type of change or a point in time of receipt of the change, i.e. the receipt of the request in step 204. The RDF triples and RDF-star triples indicate, e.g., how, i.e. in what way, the information stored in the first knowledge graph 102 has modified over time.

The RDF-star triple links to the object where the change information is stored as an RDF triple.

The type of change indicates, e.g., that a triple is added or removed, or that a triple is replaced by another triple.

The RDF triples indicate, e.g., who or what caused a change to the information stored in the first knowledge graph.

The RDF triples indicate, e.g., when, i.e. at what point in time, or how, i.e., e.g., by the client 106 or the server 108, a change to the information stored in the first knowledge graph 102 was initiated.

In step 208, a response to the request for change in the first knowledge graph 102 is determined according to the request with the second knowledge graph 104.

In step 208, the response is sent.

The response comprises, e.g., information for the change or information for how to undo the change.

The information for the change indicates, e.g., how the information stored in the first knowledge graph 102 has modified over time.

The information for the change indicates, e.g., who or what caused a change to the information stored in the first knowledge graph 102.

The information for the change indicates, e.g., when or how a change to the information stored in the first knowledge graph 102 was initiated.

For example, for the change in the first knowledge graph 102, RDF triples and RDF-star triples are determined, which represent the information about the change.

This means that a plurality of triples are determined, which together represent the change. The RDF star triples establish the link of the modified triples to the change (instances of the class provs:TripleGenerationSet or provs:TripleInvalidationSet).

The RDF triples represent the change.

The RDF-star triple is found, e.g., by the fact that it contains the modified triple in the subject.

The RDF triples indicate, e.g., how the information stored in the first knowledge graph 102 has modified over time.

The RDF triples indicate, e.g., who or what caused a change to the information stored in the first knowledge graph.

The RDF triples indicate, e.g., when or how a change to the information stored in the first knowledge graph 102 was initiated.

The change in the first knowledge graph 102 can comprise removing or adding a triple to the first knowledge graph 102.

The change in the first knowledge graph 102 can comprise updating a triple, in particular by replacing one triple with another triple.

The change history comprises, e.g., the information that indicates how the information stored in the first knowledge graph 102 has modified over time.

The change history comprises, e.g., the information that indicates who or what caused a change to the information stored in the first knowledge graph 102.

The change history comprises, e.g., the information that indicates when or how a change to the information stored in the first knowledge graph was initiated.

FIG. 3 schematically illustrates a particularly computer-implemented data structure 300 for providing and/or storing a change history of the first knowledge graph 102.

The data structure 300 comprises at least one data field 302 for the second knowledge graph 104.

In the example, the data structure comprises data fields 302 for the triples of the second knowledge graph 104.

This means that the data structure 300 comprises data fields 302 for the triples of the first knowledge graph 102 stored in the second knowledge graph 104 and additionally the change history, i.e. triples that represent the information about the changes.

The data structure 300 comprises data fields 302 for RDF-star triples that contain the modified triples in the subject and link to an object. The data structure 300 comprises, e.g., data fields 302 for at least one triple of the change history that comprises a triple of the first knowledge graph 102 as the subject. The at least one triple comprises a predicate and a change history object. The predicate and the object of the at least one triple of the change history link the triple of the first knowledge graph 102 with a subgraph of the second knowledge graph 104. The subgraph comprises the information about the change made to the first knowledge graph 102. In the example, the subgraph is an RDF graph. The RDF graph comprises the above-described RDF triples and the RDF star triples.

The data fields 302 are different, for example, in that data fields 302 for triples of the first knowledge graph 102 and data fields 302 for the change history, i.e. for RDF-star triples that link to the information about the changes, are marked differently in the respective data field 302 itself or in the data structure 300.

This means that the data structure 300 comprises data fields 302 for the change history.

The change history comprises at least one triple that comprises a triple of the first knowledge graph 102 as the subject. The at least one triple includes a predicate and an object. The predicate and the object of the at least one triple of the change history link the triple of the first knowledge graph 102 with a subgraph of the second knowledge graph 104. The subgraph comprises the information about the change made to the first knowledge graph 102. In the example, the subgraph is an RDF graph. The RDF graph comprises the above-described RDF triples and the RDF star triples.

What is claimed is:

1. A device for providing and/or storing a change history of a first knowledge graph, the device comprising:
at least one non-volatile memory, wherein a second knowledge graph is stored on the at least one memory, wherein the second knowledge graph includes at least a part of the first knowledge graph, wherein the second knowledge graph includes the change history, wherein the change history includes at least one triple that includes a triple of the first knowledge graph as a subject, wherein the at least one triple includes a predicate and an object, wherein the predicate and the object link the triple of the first knowledge graph to a subgraph of the second knowledge graph, the subgraph including an RDF graph in the second knowledge graph, and includes information about a change made to the first knowledge graph.

2. The device according to claim 1, wherein the information indicates how the information stored in the first knowledge graph: (i) has been modified over time, or (ii) who or what caused the change to the information stored in the first knowledge graph, or (iii) when or how the change to the information stored in the first knowledge graph was initiated.

3. The device according to claim 1, wherein the first knowledge graph includes information: (i) from a domain of: physics, or chemistry, or medicine, or biology, or (ii) about a technical system including a factory or a building or a vehicle or a sensor or a digital imaging system or a computer network or a heating and/or cooling system, or (iii) about a digital twin of a factory or a building or a vehicle or a sensor or a digital imaging system or a computer network or a heating and/or cooling system.

4. The device according to claim 1, wherein a plurality of triples of the first knowledge graph affected by the change are incorporated in a subject of a respective triple of the change history, wherein the respective triples of the change history include the same object and the same predicate.

5. The device according to claim 1, wherein the device further comprises a computing device configured to receive the change and to store the change in the second knowledge graph, and wherein the device is configured to receive the information or to determine the information according to: (i) the received change or (ii) a type of change or (iii) a point in time of receipt of the change, and to store the information as part of the change history in the second knowledge graph.

6. The device according to claim 5, wherein the computing device is configured to receive a request including a SPARQL star query, for a change, wherein the device is configured to determine a response to the request with the second knowledge graph according to the request, wherein the computing device is designed to send the response, wherein the response includes information for the change or information for undoing the change, wherein the information for the change indicates: (i) how the information stored in the first knowledge graph has modified over time, or (ii) who or what caused the change to the information stored in the first knowledge graph or (iii) when or how the change to the information stored in the first knowledge graph was initiated.

7. The device according to claim 1, wherein: (i) the change in the first knowledge graph includes removing the triple from the first knowledge graph or adding the triple to the first knowledge graph, or (ii) the change in the first knowledge graph includes updating the triple in the first knowledge graph by replacing the triple with another triple.

8. A method for providing and/or storing a change history of a first knowledge graph, the method comprising the following steps:
providing a second knowledge graph, wherein the second knowledge graph includes at least a part of the first knowledge graph, wherein the second knowledge graph includes the change history, wherein the change history includes at least one triple that includes a triple of the first knowledge graph as a subject, and wherein the at least one triple includes a predicate and an object, wherein the predicate and the object link the triple of the first knowledge graph to a subgraph of the second knowledge graph, the subgraph including an RDF graph in the second knowledge graph and includes information about the change made to the first knowledge graph.

9. The method according to claim 8, further comprising:
providing the change history, wherein: (i) the information indicates how the information stored in the first knowledge graph has modified over time, or (ii) the information indicates who or what caused the change to the information stored in the first knowledge graph, or (iii) the information includes when or how the change to the information stored in the first knowledge graph was initiated.

10. The method according to claim 8, wherein the first knowledge graph includes: (i) information from a domain of physics or chemistry or medicine or biology, or (ii) information about a technical system including a factory or a building or a vehicle or a sensor or a digital imaging system or a computer network or a heating and/or cooling system, or (iii) information about a digital twin of a factory or a building or a vehicle or a sensor or a digital imaging system or a computer network or a heating and/or cooling system.

11. The method according to claim 8, wherein a plurality of triples modified by the change are incorporated in a subject of one triple each of the change history, wherein the respective triples of the change history include the same object and the same predicate.

12. The method according to claim 8, wherein the change in the first knowledge graph is received and stored in the second knowledge graph, and wherein: (i) the information about the change is received in the second knowledge graph or is determined according to the received change or a type of change or a point in time of receipt of the change, and is stored as part of the change history in the second knowledge graph, and/or (ii) a request for a change in the first knowledge graph is received, a response to the request is determined with the second knowledge graph according to the request, and the response is sent, wherein the response includes information for the change or information for undoing the change, wherein the information for the change indicates: (i) how the information stored in the first knowledge graph has been modified over time, or (ii) who or what caused the change to the information stored in the first knowledge graph, or (iii) when or how the change to the information stored in the first knowledge graph was initiated.

13. The method according to claim 8, wherein the change in the first knowledge graph includes: (i) removing the triple from the first knowledge graph or (ii) adding the triple to the first knowledge graph, or the change in the first knowledge graph includes updating the triple in the first knowledge graph by replacing the triple in the first knowledge graph with another triple.

14. A computer-implemented data structure, for providing and/or storing a change history of a first knowledge graph, the data structure comprises at least one data field for a second knowledge graph including triples of the second knowledge graph, wherein the second knowledge graph includes at least a part of the first knowledge graph, wherein the second knowledge graph includes the change history, wherein the change history includes at least one triple that comprises a triple of the first knowledge graph as a subject, wherein the at least one triple includes a predicate and an object, wherein the predicate and the object link the triple of the first knowledge graph to a subgraph of the second knowledge graph, the subgraph including an RDF graph in the second knowledge graph, and the subgraph includes information about the change made to the first knowledge graph.
